(19) United States
(12) Patent Application Publication
(10) Pub. No.: US 2005/0043057 A1
(43) Pub. Date: Feb. 24, 2005

(54) TRANSFERRING DEVICE FOR TRANSMITTING IMAGES CAPTURED BY A DIGITAL CAMERA TO A MOBILE PHONE

(76) Inventor: Jui-Hsiang Lo, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,835

(22) Filed: Oct. 30, 2003

(30) Foreign Application Priority Data
Aug. 18, 2003 (TW) 092122668

(51) Int. Cl. H04M 1/00

(52) U.S. Cl. 455/556.1; 455/566

(57) ABSTRACT

A transferring device for transmitting an image captured by a digital camera to a mobile phone. The digital camera comprises a housing and an outputting port that is installed on the housing of the digital camera and is a slave interface. The mobile phone comprises a housing and a receiving port that is installed on the housing of the mobile phone and is a slave interface. The transferring device comprises a receiving module which is a host interface for connecting to the outputting port of the digital camera and receiving image data from the digital camera, a memory for storing image data from the digital camera, a control module for controlling the transferring device, and an outputting module which is a host interface for connecting the receiving port of the mobile phone and outputting image data from the digital camera to the mobile phone.

### BACKGROUND OF INVENTION

1. Field of the Invention

The present invention relates to a transferring device, and more specifically, to a transferring device for transmitting image data captured by a digital camera to a mobile phone.

2. Description of the Prior Art

Nowadays mobile phones have become very popular because of the decreasing price and the improvement of technology. So more and more mobile phones enter the market. Manufacturers also add more additional features and functions in their mobile phones to satisfy all kinds of consumers, like sending personal words and images to another mobile phone, browsing the internet, receiving and sending email, listening to the radio, and even providing an image capturing function by an internal or external phone camera and sending photos by MMS.

However the prior art conventional phone camera only provides the functions of capturing an image and sending the captured image, and cannot provide the additional editing functions for captured images. That is, the conventional phone camera often uses the DSC IC, which does not provide image-editing and special effect functions. So the image captured by the phone camera is limited to its original picture instead of being edited and always does not satisfy users in its image quality due to the limitative function and the low resolution of the phone camera.

Nowadays mobile phones have become very popular because of the decreasing price and the improvement of technology and they are trending to replace conventional negative cameras. However conventional mobile phones and digital cameras are slave devices so they cannot be connected with each other. It is a pity that mobile phones cannot use digital cameras with powerful functions and better image-capturing quality to capture images.

### SUMMARY OF INVENTION

It is therefore a primary objective of the present invention to provide a transferring device for transmitting image data captured by a digital camera to a mobile phone.

Briefly summarized, a transferring device for transmitting an image captured by a digital camera to a mobile phone is proposed. The digital camera comprises a housing and an outputting port that is installed on the housing of the digital camera and is a slave interface. The mobile phone comprises a housing and a receiving port that is installed on the housing of the mobile phone and is a slave interface. The transferring device comprises a receiving module which is a host interface for connecting to the outputting port of the digital camera and receiving image data from the digital camera, a memory for storing image data from the digital camera, a control module for controlling the transferring device, and an outputting module which is a host interface for connecting the receiving port of the mobile phone and outputting image data from the digital camera to the mobile phone.

Briefly summarized, a method for transmitting image data captured by a digital camera to a mobile phone is proposed. The digital camera comprises a housing and an outputting port, which is installed on the housing of the digital camera and is a slave interface. The mobile phone comprises a housing and a receiving port that is installed on the housing of the mobile phone and is a slave interface. The method includes providing a transferring device, using the transferring device to receive image data captured by the digital camera from the outputting port of the digital camera, and using the transferring device to transmit image data captured by the digital camera to the receiving port of the mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a transferring device connected to a digital camera and a mobile phone according to the present invention.

FIG. 2 is a block diagram of the transferring device.

FIG. 3 contains a flowchart illustrating actions taken by the transferring device to transmit image data captured by the digital camera to the mobile phone according to the present invention.

### DETAILED DESCRIPTION

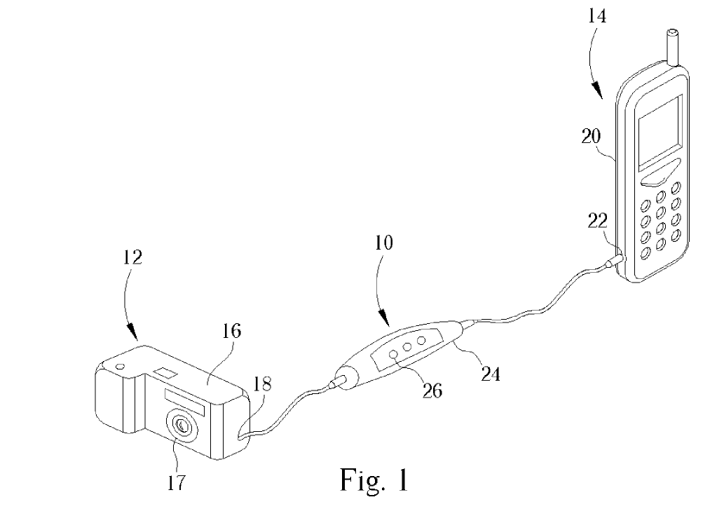

Please refer to FIG. 1. FIG. 1 is a diagram of a transferring device 10 connected to a digital camera 12 and a mobile phone 14 according to the present invention. The digital camera 12 includes a housing 16, a lens 17 for capturing an image, and an outputting port 18 installed on the housing 16 of the digital camera 12. The outputting port contains a slave interface. The mobile phone 14 includes a housing 20 and a receiving port 22 installed on the housing 20 of the mobile phone 14. The receiving port 18 contains a slave interface. The transferring device 10 is connected to the digital camera 12 via the outputting port 18 of the digital camera 12 and connected to the mobile phone 14 via the receiving port 22 of the mobile phone 14. The transferring device 10 includes a housing 24, and a plurality of control buttons 26 installed on the housing 24 of the transferring device 10, with which users can input a control signal to control the transferring device 10 by the control buttons.

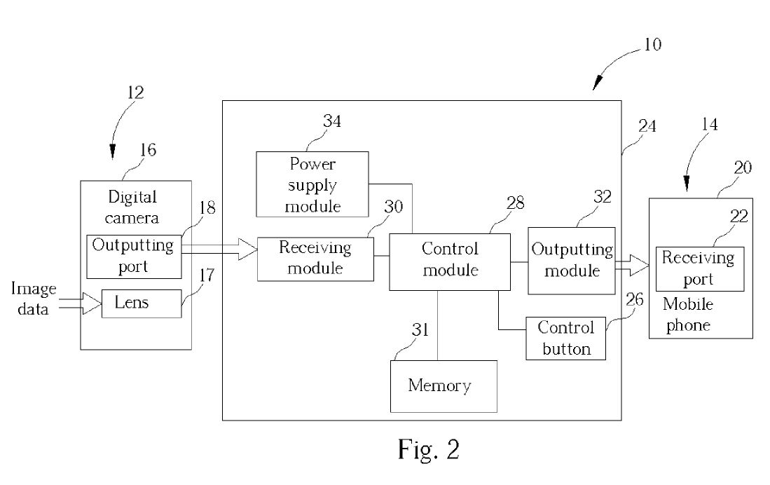

Please refer to FIG. 2. FIG. 2 is a block diagram of the transferring device 10. The transferring device 10 includes a control module 28 installed inside the housing 24 of the transferring device 10 for controlling the transferring device 10, a receiving module 30 installed inside the housing 24 of the transferring device 10 for connecting to the outputting port 18 on the housing 16 of the digital camera 12 and receiving data from the digital camera 12, a memory 31 installed inside the housing 24 of the transferring device 10 and connected to the control module 28 for storing data from the digital camera 12. The transferring device further includes an outputting module 32 which contains a slave interface for connecting the receiving port 22 on the housing 20 of the mobile phone 14 and outputting data captured by the digital camera 12 to the receiving port 22, and a power supply module 34 installed inside the housing 24 of the transferring device 10 for receiving external electric power and supplying the electric power to the transferring device 10.

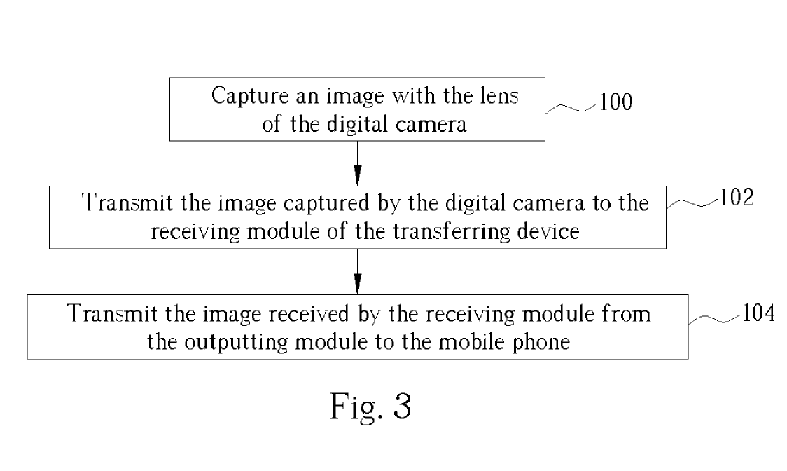

FIG. 3 contains a flowchart illustrating actions taken by the transferring device 10 to transmit image data captured by the digital camera 12 to the mobile phone 14 according to the present invention. The method includes:
Step 100: capture an image with the lens 17 of the digital camera 12;
Step 102: transmit the image captured by the digital camera 12 from the outputting port 18 of the digital camera 12 to the receiving module 30 of the transferring device 10; and
Step 104: transmit the image received by the receiving module 30 from the outputting module 32 to the receiving port 22 of the mobile phone 14.

The detailed description of the present invention method is as follows. First users can use the digital camera 12 to capture an image. Then the image captured by the digital camera 12 can be transmitted from the outputting port 18 of the digital camera 12 to the receiving module 30 of the transferring device 10. The transmission interface between the receiving module 30 and the outputting port 18 of the digital mobile 12 can be not only Pop-Port™, USB-OTG interface or other type interface, but also in the Bluetooth wireless network protocol or in infrared technology. Because the receiving module 30 of the transferring device 10 contains a host interface and the outputting port 18 of the digital camera 12 contains a slave interface, the receiving module 30 of the transferring device 10 can control the outputting port 18 to output image data to the receiving module 30. After the transferring device 10 receives the image from the digital camera 12, users can store the image in the memory 31 or transmit the image to the outputting module 32 of the transferring device 10. The image received by the receiving module 30 can be read by the control module 28 and transmitted to the outputting module 32. Moreover the image stored in the memory 31 can be read by the control module 28 and transmitted to the outputting module 32. The image mentioned above from the control module 28 will be transmitted from the outputting module 32 to the receiving port 22 of the mobile phone 14. The transmission interface between the outputting module 32 and the receiving port 22 of the mobile phone 14 can be not only Pop-Port™, USB-OTG interface or other type interface, but also in the Bluetooth wireless network protocol or in infrared technology. Because the outputting module 32 of the transferring device 10 contains a host interface and the receiving port 22 of the mobile phone 14 contains a slave interface, the outputting module 32 of the transferring device 10 can control the receiving port 22 to receive image data from the outputting module 32. As mentioned above, users can use the control buttons 26 on the housing 24 to input a control signal for storing the image from the digital camera 12 in the memory 31, transmitting the image from the digital camera 12 to the mobile phone 14, or loading the image stored in the memory 31 to the mobile phone 14.

Because the receiving module 30 and the outputting module 32 are both host interface modules, they can be USB OTG chips with host function. The host system of the transferring device 10 can be connected to the slave system of the digital camera 12 and the slave system of the mobile phone 14. That is, the transferring device can be regarded as a computer for the digital camera 12. The transferring device 10 can be regarded as a computer or a phone camera for the mobile phone 14. For example, first the transferring device 10 can read the identification code stored in the ID chip of the digital camera 12. If the identification code is identical, the transferring device 10 and the digital camera 12 are compatible. The mobile phone 14 also can read the identification code stored in the transferring device 10. If the identification code is identical, the mobile phone 14 and the transferring device 10 are compatible. And then the transferring device 10 will execute a hand-shaking procedure with the digital camera 12 and the mobile phone 14. That is, after the transferring device 10 outputs a control signal to the digital camera 12, the digital camera 12 will return an acknowledgement signal to the transferring device 10 and then the digital camera 12 and the transferring device 10 can communicate image data with each other. Similarly after the transferring device 10 outputs a control signal to the mobile phone 14, the mobile phone 14 will return an acknowledgement signal to the transferring device 10 and then the mobile phone 14 and the transferring device 10 can communicate image data with each other. In the hand-shaking procedure, the transferring device 10 can be a host system for the digital camera 12, so the transferring device 10 can be regarded as a computer for the digital camera 12 and the digital camera 12 can be regarded as a peripheral device for the computer. The computer can access data from the peripheral device or control the operation of the peripheral device. Similarly in the hand-shaking procedure, the transferring device 10 can be regarded as a phone camera compatible for the mobile phone 14 and the transferring device 10 can transmit image data from the digital camera 12 to the mobile phone 14 one by one, like the working principle of the phone camera. Additionally if the transferring module 10 receives image data from the digital camera 12 in a USB interface, the image data can be transmitted to the mobile phone 14 in other communication protocols so as to connect the digital camera 12 and the mobile phone 14 in a right way and provide the solution of transferring with different interfaces.

In contrast to the prior art, the present invention provides the transferring device 10 for connecting the mobile phone 14 and the digital camera 12 and making the conventional digital camera 12 be used by the mobile phone 14. Therefore users do not have to buy an additional phone camera to capture images for the mobile phone 14, and can enjoy more powerful functions and better image quality with digital cameras than phone cameras. Furthermore the image data received from the digital camera 12 in the digital camera 12 can be sent to other people by the MMS function or stored in the memory of the digital camera 12 to create a personal desktop or schematic item for enjoying the high quality of the capturing images.

Those skilled in the art will readily observe that numerous modifications and alterations of the device and the method may be made while retaining the teachings of the invention. Accordingly, the above disclosure should be construed as limited only by the metes and bounds of the appended claims.

1. A transferring device for transmitting an image captured by a digital camera to a mobile phone, the digital camera comprising a housing and an outputting port which is installed on the housing of the digital camera and is a slave interface, the mobile phone comprising a housing and a receiving port which is installed on the housing of the mobile phone and is a slave interface, the transferring device comprising:
a housing;
a receiving module which is installed inside the housing of the transferring device and is a host interface for connecting to the outputting port of the digital camera and receiving image data from the digital camera;
a memory installed inside the housing of the transferring device for storing image data from the digital camera;
a control module installed inside the housing of the transferring device for controlling the transferring device; and
an outputting module which is installed inside the housing of the transferring device and is a host interface for connecting the receiving port of the mobile phone and outputting image data from the digital camera to the mobile phone.

2. The transferring device of claim 1 wherein the receiving module contains a USB interface.

3. The transferring device of claim 1 wherein the receiving module contains a Pop-Port™ interface.

4. The transferring device of claim 1 wherein the outputting module contains a USB-OTG interface.

5. The image editing device of claim 1 wherein the outputting module contains a Pop-Port™ interface.

6. The transferring device of claim 1 wherein the outputting module communicates with the mobile phone in the Bluetooth wireless network protocol.

7. The transferring device of claim 1 wherein the outputting module communicates with the mobile phone by infrared technology.

8. The transferring device of claim 1 further comprises a plurality of control buttons installed on the housing of the transferring device for inputting a control signal.

9. The transferring device of claim 1 further comprising a power supply module installed inside the housing of the transferring device for receiving external electric power and supplying electric power to the transferring device.

10. A method for transmitting image data captured by a digital camera to a mobile phone, the digital camera comprising a housing and an outputting port which is installed on the housing of the digital camera and is a slave interface, the mobile phone comprising a housing and a receiving port which is installed on the housing of the mobile phone and is a slave interface, the method comprising:
providing a transferring device;
using the transferring device to receive image data captured by the digital camera from the outputting port of the digital camera; and
using the transferring device to transmit image data captured by the digital camera to the receiving port of the mobile phone.

11. The method of claim 10 wherein the transferring device comprises:
a housing;
a receiving module which is installed inside the housing of the transferring device and is a host interface for connecting to the outputting port of the digital camera and receiving image data from the digital camera; a memory installed inside the housing of the transferring device for storing image data from the digital camera;
a control module installed inside the housing of the transferring device for controlling the transferring device; and
an outputting module which is installed inside the housing of the transferring device and is a host interface for connecting the receiving port of the mobile phone and outputting image data from the digital camera to the mobile phone.

12. The method of claim 11 wherein the receiving module contains a USB interface.

13. The method of claim 11 wherein the receiving module contains a Pop-Port™ interface.

14. The method of claim 11 wherein the outputting module contains a USB-OTG interface.

15. The method of claim 11 wherein the outputting module contains a Pop-Port™ interface.

16. The method of claim 11 wherein the outputting module communicates with the mobile phone in the Bluetooth wireless network protocol.

17. The method of claim 11 wherein the outputting module communicates with the mobile phone by infrared technology.

18. The method of claim 11 wherein the transferring device further comprises a plurality of control buttons installed on the housing of the transferring device for inputting a control signal.

19. The method of claim 11 wherein the transferring device further comprises a power supply module installed inside the housing of the transferring device for receiving external electric power and supplying electric power to the transferring device.
